(19) United States
(12) Patent Application Publication
(10) Pub. No.: US 2026/0081305 A1
(43) Pub. Date: Mar. 19, 2026

(54) DIELECTRIC THIN FILM FOR SOLID-STATE OR SEMI-SOLID LITHIUM BATTERY

(71) Applicant: Zhi Feng Luo, Shenzhen (CN)

(72) Inventor: Zhi Feng Luo, Shenzhen (CN)

(21) Appl. No.: 18/888,192

(22) Filed: Sep. 18, 2024

(51) Int. Cl. H01M 50/457; H01M 10/052; H01M 10/056; H01M 50/42; H01M 50/426; H01M 50/446

(52) U.S. Cl. CPC H01M 50/457; H01M 10/052; H01M 10/056; H01M 50/42; H01M 50/426; H01M 50/446; H01M 2300/0065; H01M 2300/0091

(57) ABSTRACT

A dielectric thin film for a solid-state or semi-solid lithium battery, wherein the dielectric thin film is connected between a negative electrode and a positive electrode of the lithium battery. The dielectric thin film includes a first film layer connected to the positive electrode, a third film layer connected to the negative electrode, and a second film layer connected between the first film layer and the third film layer. The first film layer includes a first polymer material and a first lithium salt. The second film layer includes a second polymer material, a second lithium salt and a second inorganic ceramic structure. The third film layer includes a third polymer material, a third lithium salt and a third inorganic ceramic structure.

### FIELD OF THE INVENTION

The present invention is related to a dielectric thin film in a battery, and in particular to a dielectric thin film for a solid-state or semi-solid lithium battery.

### BACKGROUND OF THE INVENTION

In the prior arts, a solid-state or semi-solid lithium battery includes a negative (−) electrode, a positive (+) electrode, and a dielectric thin film connected between the negative electrode and the positive electrode. The negative electrode includes a negative electrode slurry which is used as a binder, and a plurality of negative electrode particles dispersed in the negative electrode slurry. The positive electrode includes a positive electrode slurry which is used as a binder, and a plurality of positive electrode particles dispersed in the positive electrode slurry. The dielectric thin film serves to isolate and connect the negative electrode and the positive electrode.

The positive and negative electrode slurries serve to conduct the lithium ions. However, the negative and positive electrode slurries are easy to perform a side reaction with the lithium ions to cause a lithium death or lithium depletion, which is an irreversible chemical reaction, resulting in the number of lithium ions in the battery becomes smaller and smaller, so that the capacity of battery to store electricity is also reduced. Moreover, the lithium ion capacity of the positive and negative electrode particles is poor, so the lithium ions in the positive and negative electrode slurries tend to cluster on the surface of the positive and negative electrode particles, which causes the lithium ions perform a side reaction with the positive and negative electrode slurries and the capacitance of the entire positive and negative electrodes are reduced. The number of lithium ions in the battery also becomes smaller and the capacity of battery to store electricity is reduced.

The conventional dielectric thin film is a single-layer structure which has a rigid structure and a low concentration of lithium salt. Therefore, when the dielectric thin film is bonded to the positive electrode, the stacking between the dielectric thin film and the positive electrode is not tight, resulting in a poor structure and bonding. The conventional dielectric thin film is also unable to fill the cracks between the positive electrode and the dielectric thin film, which easily causes a short-circuit and a reduction in the yield.

Moreover, the conventional dielectric thin film only has a single specific concentration of lithium salt, so the lithium ions require a higher conduction energy level, resulting in a poor ionic conductivity and a lower overall battery performance. When a single-layer dielectric thin film is bonded to the negative electrode, the ionic conductivity is also poor, making the negative electrode to form a dead lithium deposition, increasing the risk of lithium crystal formation and puncture, and thus reducing the battery's storage capacity.

### SUMMARY OF THE INVENTION

Accordingly, for improving above mentioned defects in the prior art, the object of the present invention is to provide a dielectric thin film for a solid-state or semi-solid lithium battery, wherein a first film layer and a third film layer are added respectively to two sides of a single-layer dielectric thin film to form a three-layer dielectric thin film. The first film layer and third film layer have a soft structure to be easily filled in the gap between the positive electrode and the negative electrode, which improve the fit and adhesion between the dielectric thin film, positive electrode and negative electrode, increase the battery performance, reduce the risk of short-circuit, and improve the battery yield.

To achieve above object, the present invention provides A dielectric thin film for a solid-state or semi-solid lithium battery, wherein the lithium battery includes a negative electrode and a positive electrode; the dielectric thin film is connected between the negative electrode and the positive electrode; the negative electrode includes a negative electrode slurry which is used as a binder, and a plurality of negative electrode particles dispersed in the negative electrode slurry; the positive electrode includes a positive electrode slurry which is used as a binder, and a plurality of positive electrode particles dispersed in the positive electrode slurry; the dielectric thin film comprising: a first film layer, a second film layer and a third film layer; the first film layer being connected to the positive electrode and the third film layer being connected to the negative electrode; the second film layer being connected between the first film layer and the third film layer; the first film layer including: a first polymer material which is used as a base material of the first film layer; the first polymer material being a mixture of PVDF-HFP (Polyvinylidene luoride-hexafluoropropylene copolymer), ADN (Adiponitrile), GLN (Glutaronitrile) and SN (Succinonitrile); each of the ADN, GLN and SN in the first polymer material being used as a plasticizer and is dispersed in the PVDF-HFP for dispersing a structure of the first polymer material; a first lithium salt dispersed in the first polymer material; the first lithium salt being a mixture of LiBOB (LiB(C₂O₄)₂, Lithium bis(oxalate)borate), LiTFSI (LiN(CF₃SO₂)₂, Lithium bis(trifluoromethanesulfonyl)imide), and LiFSI (F₂LiNO₄S₂ [symbol] Lithium bis(fluorosulfonyl)imide); wherein the ADN, GLN and SN in the first polymer material serve to reduce a crystal precipitation of the first polymer material and to aid in a dissociation of the first lithium salt in the first film layer, which increases a lithium ion conductivity and a formability of the first film layer; the second film layer including: a second polymer material which is used as a base material of the second film layer; the second polymer material being a mixture of PVDF-HFP, PAN (Polyacrylonitrile) and SN; each of the PAN and SN in the second polymer material being used as a plasticizer and is dispersed in the PVDF-HFP; a second lithium salt dispersed in the second polymer material; the second lithium salt being a mixture of LiFSI and LiTFSI; the PAN and SN in the second polymer material serving to reduce a crystal precipitation of the second polymer material and to aid in a dissociation of the second lithium salt for increasing a lithium ion conductivity of the second film layer; a second inorganic ceramic structure formed by a plurality of first LLZO particles which are dispersed in the second polymer material; an outer surface of each of the first LLZO particles being coated by a first dopamine (DA, 3,4-dihydroxyphenethylamine) layer; each of the first LLZO particles being formed by LLZO (lithium lanthanum zirconium oxide, Li₇La₃Zr₂O₁₂) or LLZO doped with at least one metal; and the third film layer including: a third polymer material which is used as a base material of the third film layer; the third polymer material being a mixture of PEO (Poly(ethylene oxide), polyethylene oxide) and PAN; the PAN in the third polymer material being used as a plasticizer and being dispersed in the PEO; a third lithium salt formed by LiTFSI and dispersed in the third polymer material; a third inorganic ceramic structure formed by a plurality of second LLZO particles which are dispersed in the third polymer material; an outer surface of each of the second LLZO particles being coated by a second dopamine layer; each of the second LLZO particles being formed by LLZO or LLZO doped with at least one metal; and the third inorganic ceramic structure serving to increase a lithium ion conductivity of the negative electrode.

### BRIEF DESCRIPTION OF THE DRAWINGS

FIG. 1 is a schematic view showing the negative electrode, the dielectric thin film, and the positive electrode of the present invention.

FIG. 2 is a schematic view showing the structure of the dielectric thin film of the present invention.

FIG. 3 is a schematic view showing the first LLZO particle of the present invention.

FIG. 4 is a schematic view showing the second LLZO particle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

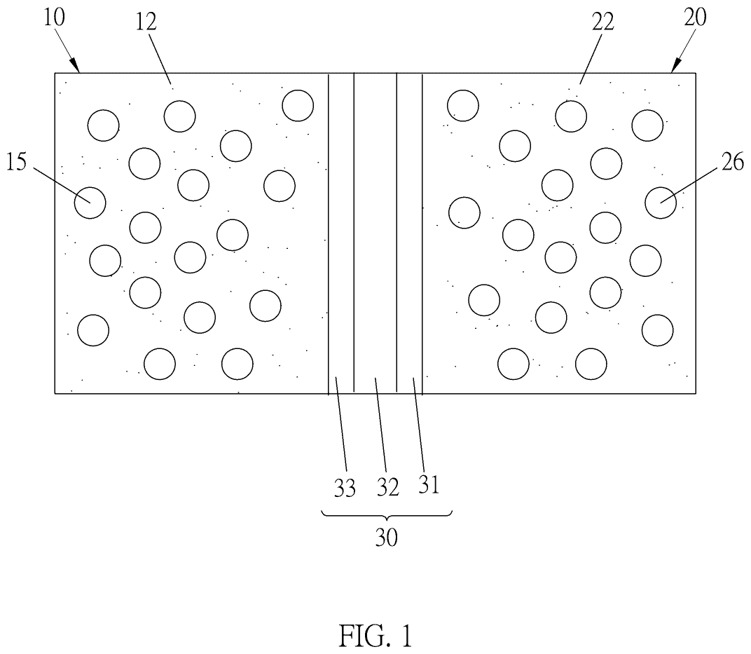

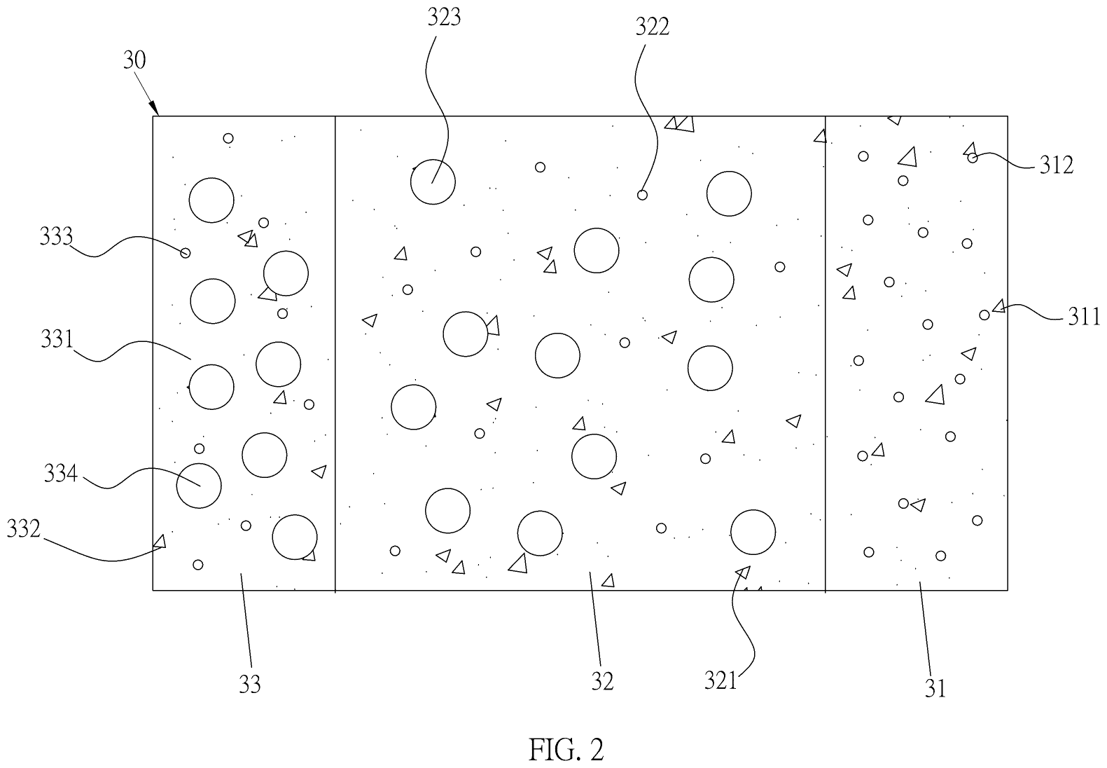

With reference to FIGS. 1 to 4, the present invention provides a dielectric thin film 30 for a solid-state or semi-solid lithium battery, wherein the lithium battery includes a negative (−) electrode 10 and a positive (+) electrode 20. The dielectric thin film 30 is connected between the negative electrode 10 and the positive electrode 20 (as shown in FIG. 2). The negative electrode 10 includes a negative electrode slurry 12 which is used as a binder, and a plurality of negative electrode particles 15 (such as silicon carbide (SiC) particles with a tin (Sn) layer) dispersed in the negative electrode slurry 12. An outer surface of the negative electrode particles 15 accommodates lithium ions and has a function of uniformly conducting the lithium ions in the negative electrode 10. The negative electrode particles 15 will perform a side reaction with some of the lithium ions to reduce the number of lithium ions that can be used, which will reduce the capacitance capability of the entire lithium battery in the long run. The positive electrode 20 includes a positive electrode slurry 22 which is used as a binder, and a plurality of positive electrode particles 26 dispersed in the positive electrode slurry 22. The positive electrode slurry and the positive electrode particles 26 will perform a side reaction with the lithium ions passing the positive electrode 20, which depletes the lithium ions which can be acted.

Referring to FIGS. 1 and 2, the dielectric thin film 30 is positioned between the negative electrode 10 and the positive electrode 20 for isolating and connecting the negative electrode 10 and the positive electrode 20. The dielectric thin film 30 comprises the following elements.

A first film layer 31, a second film layer 32 and a third film layer 33. The first film layer 31 is connected to the positive electrode 20 and the third film layer 33 is connected to the negative electrode 10. The second film layer 32 is connected between the first film layer 31 and the third film layer 33.

The first film layer 31 includes:
A first polymer material 311 is used as a base material of the first film layer 31. The first polymer material 311 is a mixture of PVDF-HFP (Polyvinylidene luoride-hexafluoropropylene copolymer), ADN (Adiponitrile), GLN (Glutaronitrile) and SN (Succinonitrile). In the first polymer material 311, a ratio of a weight of the PVDF-HFP and “a total weight of the ADN, GLN and SN” is 12:1 to 8:1.
Each of the ADN, GLN and SN in the first polymer material 311 is used as a plasticizer and is dispersed in the PVDF-HFP for dispersing a structure of the first polymer material 311 to reduce the crystal precipitation of the first polymer material 311 and to aid in the dissociation of the lithium salt (a first lithium salt 312 defined in the description below) in the first film layer 31, and thus to increase a lithium ion conductivity and a formability of the first film layer 31. A ratio of a weight of the ADN, a weight of the GLN and a weight of the SN is 1:2:7 to 0.5:1:9.5.
A first lithium salt 312 is dispersed in the first polymer material 311. The first lithium salt 312 is a mixture of LiBOB (LiB(C₂O₄)₂, Lithium bis(oxalate)borate), LiTFSI (LiN(CF₃SO₂)₂, Lithium bis(trifluoromethanesulfonyl)imide), and LiFSI (F₂LiNO₄S₂ [symbol] Lithium bis(fluorosulfonyl)imide). A ratio of a weight of the first lithium salt 312 and a weight of the first polymer material 311 is 1:2.5 to 1:5. The LiTFSI and LiFSI serve to increase a conductivity of the lithium ions. The LiBOB serves to prevent the LiTFSI and the LiFSI from being corroded by a water and from being attacked by HF (hydrofluoric acid) generated by a reaction between the water and the LiTFSI, which prevents a degradation of the performance of the lithium battery, and enables the first lithium salt 312 to withstand a higher voltage difference. Therefore, the first polymeric material 311 can be relatively stable under a high-voltage action of the positive electrode 20. In the first film layer 31, a ratio of “a total weight of the LiTFSI and LiFSI” and a weight of the LiBOB is 2:3. A ratio of a weight of the LiFSI and a weight of the LiTFSI is 2:1.

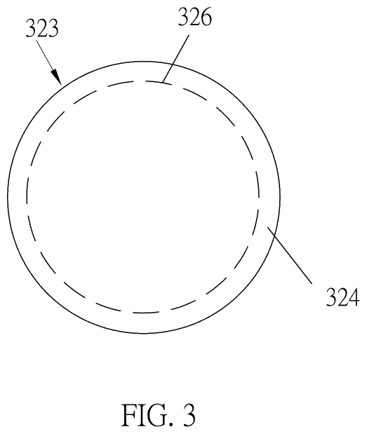

The second film layer 32 includes:
A second polymer material 321 is used as a base material of the second film layer 32. The second polymer material 321 is a mixture of PVDF-HFP, PAN (Polyacrylonitrile) and SN. In the second polymer material 321, a ratio of a weight of the PVDF-HFP, a weight of the PAN and a weight of the SN is 8:1.2:1 to 8:1:1.6.
Each of the PAN and SN in the second polymer material 321 is used as a plasticizer and is dispersed in the PVDF-HFP for dispersing a structure of the second polymer material 321 to reduce the crystal precipitation of the second polymer material 321 and to aid in the dissociation of the lithium salt (a second lithium salt 322 defined in the description below) in the second polymer material 321 for increasing the lithium ion conductivity of the second film layer 32.
A second lithium salt 322 is dispersed in the second polymer material 321. The second lithium salt 322 is a mixture of LiFSI and LiTFSI. In the second lithium salt 322, a ratio of a weight of the LiFSI and a weight of the LiTFSI is 1:2. The second lithium salt 322 serves to reduce an energy level that the lithium ions required to cross in order to conduct in the polymer material, which increases the stability and conductivity. A ratio of a weight of the second lithium salt 322 and a weight of the second polymer material 321 is 1:3 to 1:9.
A second inorganic ceramic structure 323 is formed by a plurality of first LLZO particles 326 which are dispersed in the second polymer material 321. An outer surface of each of the first LLZO particles 326 is coated by a first dopamine (DA, a contraction of 3,4-dihydroxyphenethylamine) layer 324, as shown in FIG. 3. In the second film layer 32, a radial size of each of the first LLZO particles 326 is less than 100 nm. The second inorganic ceramic structure 323 serves to increase the conductivity of the lithium ions and the mechanical strength of the second film layer 32. A weight percentage of the second inorganic ceramic structure 323 in the second polymer material 321 is 8% wt to 20% wt.
Each of the first LLZO particles 326 is formed by LLZO (lithium lanthanum zirconium oxide, Li₇La₃Zr₂O₁₂) or LLZO doped with at least one metal. Preferably, each of the first LLZO particles 326 is formed by Cu-LLZO (copper-doped LLZO).
Since the PVDF-HFP in the second polymer material 321 is easy to react with the first LLZO particles 326 to cause that the second film layer 32 is unable to be easily shaped, the first dopamine layer 324 is coated on the outer surface of each of the first LLZO particles 326 to protect the first LLZO particle 326. In addition, the dopamine is a hydrophobic material, therefore the first dopamine layer 324 also serves to prevent an external water from entering into the first LLZO particle 326, which prevents the first LLZO particles 326 from being easy to form alkaline by-products when exposed to a moisture, and from performing a lithium fluoride reaction with the PVDF-HFP. The functional group of the dopamine is highly compatible with the PAN in the second polymer material 321. In each of the first LLZO particles 326, a weight percentage of the first dopamine layer 324 in the respective first LLZO particle 326 is less than 5% wt. A thickness of the first dopamine layer 324 is less than 3 nm.

### The third film layer 33 includes:

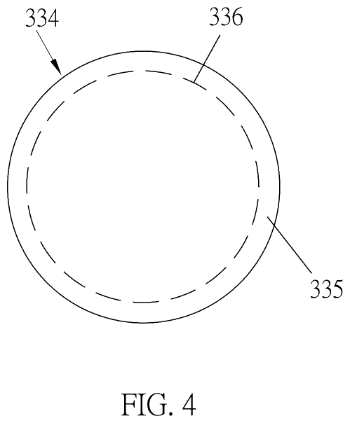

A third polymer material 331 is used as a base material of the third film layer 33. The third polymer material 331 is a mixture of PEO (Poly(ethylene oxide), polyethylene oxide) and PAN. A ratio of a weight of the PEO and a weight of the PAN is 5:1 to 8:1. The PEO has a high stability under the redox potential of the negative electrode 10 and has a good ionic conductivity. The PAN has a good electronic and ionic conductivity to increase the performance of the PEO.
The PAN in the third polymer material 331 is used as a plasticizer and is dispersed in the PEO.
An additive 332 is formed by FEC (Fluoroethylene carbonate) and is dispersed in the third polymer material 331. The additive 332 serves to help the negative electrode 10 to form a good ASEI (artificial solid electrolyte interphase). A weight percentage of the additive 332 in the third polymer material 331 is less than 10% wt.
A third lithium salt 333 is formed by LiTFSI and is dispersed in the third polymer material 331. In the formation and charging and discharging of the lithium battery, the fluorine (F) and lithium (Li) of the LiTFSI deposit on a surface of the negative electrode 10 to form LiF (lithium fluoride), which protects the negative electrode 10 to form the ASEI. The third lithium salt 333 serves to reduce an energy level that the lithium ions required to cross in order to conduct in the polymer material. A ratio of a weight of the third lithium salt 333 and a weight of the third polymer material 331 is 1:3 to 1:9.
A third inorganic ceramic structure 334 is formed by a plurality of second LLZO particles 336 which are dispersed in the third polymer material 331. An outer surface of each of the second LLZO particles 336 is coated by a second dopamine layer 335, as shown in FIG. 4. In the third film layer 33, a radial size of each of the second LLZO particles 336 is 200˜300 nm. The third inorganic ceramic structure 334 serves to increase the lithium ion conductivity of the negative electrode 10, which reduces the deposition of dead lithium, reduces the risk of lithium crystal formation and puncture, improves the mechanical properties, inhibits a part of the negative electrode expansion, and provides a source of stress. A weight percentage of the third inorganic ceramic structure 334 in the third polymer material 331 is 10% wt to 20% wt. In each of the second LLZO particles 336, a weight percentage of the second dopamine layer 335 in the respective second LLZO particle 336 is less than 5% wt. A thickness of the second dopamine layer 335 is less than 3 nm.
Each of the second LLZO particles 336 is formed by LLZO (lithium lanthanum zirconium oxide, Li₇La₃Zr₂O₁₂) or LLZO doped with at least one metal. Preferably, each of the second LLZO particles 336 is formed by Cu-LLZO (copper-doped LLZO).

The first film layer 31 does not have the inorganic ceramic structure and is a soft material, thus providing a better adhesion to the positive electrode 20. The first polymer material 311 of the first film layer 31 is a soft material which is filled in a gap between the dielectric thin film 30 and the positive electrode 20. The first lithium salt 312 of the first film layer 31 can reduce the energy level gap to increase the conductivity of the lithium ions.

A concentration (molar concentration) of the first lithium salt 312 of the first film layer 31 is higher than a concentration (molar concentration) of the second lithium salt 322 of the second film layer 32 and a concentration (molar concentration) of the third lithium salt 333 of the third film layer 33, which reduces the energy level that the lithium ions required to cross in order to conduct in the first, second and third polymer materials 311, 321, 331, which increases the conductivity.

In the present invention, the lithium salt concentration in the first, second and third film layer 31, 32, 33 decreases progressively from the first film layer 31 to the third film layer 33. That is, the concentration (molar concentration) of the first lithium salt 312 of the first film layer 31 is higher than the concentration (molar concentration) of the second lithium salt 322 of the second film layer 32; and the concentration of the second lithium salt 322 of the second film layer 32 is higher than the concentration (molar concentration) of the third lithium salt 333 of the third film layer 33.

The normal polymer material is not able to form chains effectively to form a film structure if the concentration of the polymer material is too high. In order to overcome above problem, in the present invention, the plasticizers (ADN, GLN, SN and PAN) are added into the first, second and third polymer materials 311, 321, 331, which can prevent crystals of the first, second and third polymer material 311, 321, 331 from precipitating, support the structure of the first, second and third polymer materials 311, 321, 331 and increase the structure properties of the first, second and third polymer materials 311, 321, 331. The plasticizers in the first, second and third polymer materials 311, 321, 331 are highly polar plasticizers, which allow the first, second and third lithium salts 312, 322, 333 to dissociate more easily to increase the amount of free lithium ions, resulting in a better lithium ion conductivity. As a result, the second and third inorganic ceramic structures 323, 334 in the second and third film layer 32, 33 can increase the lithium ion conductivity and the mechanical properties.

A sum of a thickness of the first film layer 31, a thickness of the second film layer 32 and a thickness of the third film layer 33 is 12 μm to 24 μm. The thickness of the second film layer 32 is 10 μm to 18 μm. The thickness of each of the first film layer 31 and the third film layer 33 is 1 μm to 3 μm.

The first film layer 31 and the third film layer 33 are used as interface connecting layers for connecting the positive electrode 20 and the negative electrode 10, respectively.

The advantages of the present invention are that a first film layer and a third film layer are added respectively to two sides of a single-layer dielectric thin film to form a three-layer dielectric thin film. The first film layer and third film layer have a soft structure to be easily filled in the gap between the positive electrode and the negative electrode, which improve the fit and adhesion between the dielectric thin film, positive electrode and negative electrode, increase the battery performance, reduce the risk of short-circuit, and improve the battery yield.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A dielectric thin film for a solid-state or semi-solid lithium battery, wherein the lithium battery includes a negative electrode and a positive electrode; the dielectric thin film is connected between the negative electrode and the positive electrode; the negative electrode includes a negative electrode slurry which is used as a binder, and a plurality of negative electrode particles dispersed in the negative electrode slurry; the positive electrode includes a positive electrode slurry which is used as a binder, and a plurality of positive electrode particles dispersed in the positive electrode slurry; the dielectric thin film comprising:
a first film layer, a second film layer and a third film layer; the first film layer being connected to the positive electrode and the third film layer being connected to the negative electrode; the second film layer being connected between the first film layer and the third film layer;
the first film layer including:
a first polymer material which is used as a base material of the first film layer; the first polymer material being a mixture of PVDF-HFP (Polyvinylidene luoride-hexafluoropropylene copolymer), ADN (Adiponitrile), GLN (Glutaronitrile) and SN (Succinonitrile); each of the ADN, GLN and SN in the first polymer material being used as a plasticizer and is dispersed in the PVDF-HFP for dispersing a structure of the first polymer material;
a first lithium salt dispersed in the first polymer material;
the first lithium salt being a mixture of LiBOB (LiB(C₂O₄)₂, Lithium bis(oxalate)borate), LiTFSI (LiN(CF₃SO₂)₂, Lithium bis(trifluoromethanesulfonyl)imide), and LiFSI (F₂LiNO₄S₂ [symbol] Lithium bis(fluorosulfonyl)imide);
wherein the ADN, GLN and SN in the first polymer material serve to reduce a crystal precipitation of the first polymer material and to aid in a dissociation of the first lithium salt in the first film layer, which increases a lithium ion conductivity and a formability of the first film layer;
the second film layer including:
a second polymer material which is used as a base material of the second film layer; the second polymer material being a mixture of PVDF-HFP, PAN (Polyacrylonitrile) and SN; each of the PAN and SN in the second polymer material being used as a plasticizer and is dispersed in the PVDF-HFP;
a second lithium salt dispersed in the second polymer material; the second lithium salt being a mixture of LiFSI and LiTFSI; the PAN and SN in the second polymer material serving to reduce a crystal precipitation of the second polymer material and to aid in a dissociation of the second lithium salt for increasing a lithium ion conductivity of the second film layer;
a second inorganic ceramic structure formed by a plurality of first LLZO particles which are dispersed in the second polymer material; an outer surface of each of the first LLZO particles being coated by a first dopamine (DA, 3,4-dihydroxyphenethylamine) layer; each of the first LLZO particles being formed by LLZO (lithium lanthanum zirconium oxide, Li₇La₃Zr₂O₁₂) or LLZO doped with at least one metal; and
the third film layer including:
a third polymer material which is used as a base material of the third film layer; the third polymer material being a mixture of PEO (Poly(ethylene oxide), polyethylene oxide) and PAN; the PAN in the third polymer material being used as a plasticizer and being dispersed in the PEO;
a third lithium salt formed by LiTFSI and dispersed in the third polymer material;
a third inorganic ceramic structure formed by a plurality of second LLZO particles which are dispersed in the third polymer material; an outer surface of each of the second LLZO particles being coated by a second dopamine layer; each of the second LLZO particles being formed by LLZO or LLZO doped with at least one metal; and the third inorganic ceramic structure serving to increase a lithium ion conductivity of the negative electrode.

2. The dielectric thin film for the solid-state or semi-solid lithium battery as claimed in claim 1, wherein in the first film layer, a ratio of a weight of the ADN, a weight of the GLN and a weight of the SN is 1:2:7 to 0.5:1:9.5 ; a ratio of a weight of the PVDF-HFP and “a total weight of the ADN, GLN and SN” is 12:1 to 8:1; a ratio of a weight of the first lithium salt 312 and a weight of the first polymer material 311 is 1:2.5 to 1:5; a ratio of “a total weight of the LiTFSI and LiFSI” and a weight of the LiBOB is 2:3; and a ratio of a weight of the LiFSI and a weight of the LiTFSI is 2:1.

3. The dielectric thin film for the solid-state or semi-solid lithium battery as claimed in claim 1, wherein in the second film layer, a ratio of a weight of the PVDF-HFP, a weight of the PAN and a weight of the SN is 8:1.2:1 to 8:1:1.6 ; a ratio of a weight of the LiFSI and a weight of the LiTFSI is 1:2; a ratio of a weight of the second lithium salt and a weight of the second polymer material is 1:3 to 1:9; a weight percentage of the second inorganic ceramic structure in the second polymer material is 8% wt to 20% wt.

4. The dielectric thin film for the solid-state or semi-solid lithium battery as claimed in claim 1, wherein in the second film layer, a radial size of each of the first LLZO particles is less than 100 nm; in each of the first LLZO particles, a weight percentage of the first dopamine layer in the respective first LLZO particle is less than 5% wt; and a thickness of the first dopamine layer is less than 3 nm.

5. The dielectric thin film for the solid-state or semi-solid lithium battery as claimed in claim 1, wherein in the third film layer, a ratio of a weight of the PEO and a weight of the PAN is 5:1 to 8:1; and a ratio of a weight of the third lithium salt and a weight of the third polymer material is 1:3 to 1:9.

6. The dielectric thin film for the solid-state or semi-solid lithium battery as claimed in claim 1, wherein the third film layer further includes an additive which is formed by FEC (Fluoroethylene carbonate) and is dispersed in the third polymer material; and the additive serves to help the negative electrode to form an ASEI (artificial solid electrolyte interphase).

7. The dielectric thin film for the solid-state or semi-solid lithium battery as claimed in claim 6, wherein a weight percentage of the additive in the third polymer material is less than 10% wt.

8. The dielectric thin film for the solid-state or semi-solid lithium battery as claimed in claim 1, wherein each of the first LLZO particles is formed by Cu-LLZO (copper-doped LLZO); each of the second LLZO particles is formed by Cu-LLZO (copper-doped LLZO).

9. The dielectric thin film for the solid-state or semi-solid lithium battery as claimed in claim 1, wherein a radial size of each of the second LLZO particles is 200˜300 nm; and a weight percentage of the third inorganic ceramic structure in the third polymer material is 10% wt to 20% wt.

10. The dielectric thin film for the solid-state or semi-solid lithium battery as claimed in claim 1, wherein a concentration of the first lithium salt of the first film layer is higher than a concentration of the second lithium salt of the second film layer; and the concentration of the second lithium salt of the second film layer is higher than a concentration of the third lithium salt of the third film layer.

11. The dielectric thin film for the solid-state or semi-solid lithium battery as claimed in claim 1, wherein a sum of a thickness of the first film layer, a thickness of the second film layer and a thickness of the third film layer is 12 μm to 24 μm; the thickness of the second film layer is 10 μm to 18 μm; and the thickness of each of the first film layer and the third film layer is 1 μm to 3 μm.

12. The dielectric thin film for the solid-state or semi-solid lithium battery as claimed in claim 1, wherein the first film layer and the third film layer are used as interface connecting layers for connecting the positive electrode and the negative electrode, respectively.
